(19) United States
(12) Patent Application Publication
(10) Pub. No.: US 2016/0033958 A1
(43) Pub. Date: Feb. 4, 2016

(54) ENDPOINT DETERMINATION USING INDIVIDUALLY MEASURED TARGET SPECTRA

(71) Applicants: GLOBALFOUNDRIES Inc., Grand Cayman (KY); International Business Machines Corporation, Armonk, NY (US)

(72) Inventors: Stan Tsai, Clifton Park, NY (US); Charan V. V. S. Surisetty, Albany, NY (US)

(21) Appl. No.: 14/449,222

(22) Filed: Aug. 1, 2014

(51) Int. Cl. G05B 19/418

(52) U.S. Cl. CPC G05B 19/418; G05B 2219/45031

(57) ABSTRACT

Disclosed are approaches for determining a processing endpoint using individually measured target spectra. More specifically, one approach includes: measuring a white light (WL) target spectra of a semiconductor device on an individual wafer prior to formation of a polishing/planarization material; inputting the WL target spectra to a WL endpoint algorithm of the semiconductor device following formation of the polishing/planarization material; and determining, using the WL endpoint algorithm, the processing endpoint of the polishing/planarization material of the semiconductor device. In another approach, the endpoint measurement process comprises receiving spectra reflected from the semiconductor device during polishing, and comparing the spectra to the WL target spectra, which is previously stored within a storage device. As such, WL target spectra are measured “as is” (e.g., without simplifications, generalizations, assumptions, etc.) for each wafer to reduce complications inherent with the use of an uncertain and/or estimated target.

### BACKGROUND

1. Field of the Invention

This invention relates generally to semiconductor device endpoint determination and, more specifically, to providing individual measured target spectra to improve endpoint determination accuracy.

2. Description of the Related Art

An integrated circuit is typically formed on a substrate by the sequential deposition of conductive, semiconductive, or insulator layers on a silicon wafer. One fabrication step involves depositing a filler layer over a non-planar surface and planarizing the filler layer. For certain applications, the filler layer is planarized until the top surface of a patterned layer is exposed. A conductive filler layer, for example, can be deposited on a patterned insulator layer to fill the trenches or holes in the insulator layer. After planarization, the portions of the conductive layer remaining between the raised pattern of the insulator layer form vias, plugs, and lines that provide conductive paths between thin film circuits on the substrate. For other applications, such as oxide polishing, the filler layer is planarized until a predetermined thickness is left over the non-planar surface. In addition, planarization of the substrate surface is usually required for photolithography.

Chemical mechanical polishing (CMP) is one accepted method of planarization. This planarization method typically requires that the substrate be mounted on a carrier or polishing head. The exposed surface of the substrate is typically placed against a rotating polishing disk pad or belt pad. The polishing pad can be either a standard pad or a fixed abrasive pad. A standard pad has a durable roughened surface, whereas a fixed-abrasive pad has abrasive particles held in a containment media. The carrier head provides a controllable load on the substrate to push it against the polishing pad. A polishing slurry is typically supplied to the surface of the polishing pad. The polishing slurry includes at least one chemically reactive agent and, if used with a standard polishing pad, abrasive particles.

One problem in CMP is determining whether the polishing process is complete, i.e., whether a substrate layer has been planarized to a desired flatness or thickness, or when a desired amount of material has been removed. Over polishing (i.e., removing too much) of a conductive layer or film leads to increased circuit resistance. On the other hand, under polishing (i.e., removing too little) of a conductive layer leads to electrical shorting. Variations in the initial thickness of the substrate layer, the slurry composition, the polishing pad condition, the relative speed between the polishing pad and the substrate, the load on the substrate, etc., can cause variations in the material removal rate. These variations cause differences in the time needed to reach the polishing endpoint. Therefore, the polishing endpoint cannot be determined merely as a function of polishing time.

In one prior art approach, white light (WL) is used as an alternative endpoint determination method because it is very sensitive. However, this approach requires an assumed/estimated target spectra. Since the WL signal is sensitive to minor changes in substrates, the assumed target is not always accurate and, therefore, often leads to mistakes determining the endpoint.

### SUMMARY

In general, disclosed are approaches for determining a processing endpoint using individually measured target spectra. More specifically, one approach includes: measuring a white light (WL) target spectra of a semiconductor device on an individual wafer prior to formation of a polishing/planarization material; inputting the WL target spectra to a WL endpoint algorithm of the semiconductor device following formation of the polishing/planarization material; and determining, using the WL endpoint algorithm, the processing endpoint of the polishing/planarization material of the semiconductor device. In another approach, the endpoint measurement process comprises receiving spectra reflected from the semiconductor device during polishing, and comparing the spectra to the WL target spectra, which is previously stored within a storage device. As such, WL target spectra are measured “as is” (e.g., without simplifications, generalizations, assumptions, etc.) for each wafer to reduce complications inherent with the use of an uncertain and/or estimated target

One aspect of the present invention includes a method for determining a processing endpoint using individually measured target spectra, the method comprising the computer-implemented steps of: measuring a white light (WL) spectra of a semiconductor device on an individual wafer prior to formation of a semiconductor material; storing the WL spectra as a target WL spectra; inputting the WL target spectra to a WL endpoint algorithm following formation of the semiconductor material; and determining, using the WL endpoint algorithm, a processing endpoint of the semiconductor material.

Another aspect of the present invention includes a computer program product for determining a processing endpoint using individually measured target spectra, the computer program product comprising: a computer readable storage device storing computer program instructions, the computer program instructions being executable by a computer processor, the computer program instructions including: measuring a white light (WL) spectra of a semiconductor device on an individual wafer prior to formation of a semiconductor material; storing the WL spectra as a target WL spectra; inputting the WL target spectra to a WL endpoint algorithm following formation of the semiconductor material; and determining, using the WL endpoint algorithm, a processing endpoint of the semiconductor material.

Another aspect of the present invention includes a method for determining a processing endpoint using individually measured target spectra, the method comprising: measuring a white light (WL) spectra of a semiconductor device on an individual wafer prior to formation of a semiconductor material; storing the WL spectra as a target WL spectra; inputting, by a computer processor, the WL target spectra to a WL endpoint algorithm following formation of the semiconductor material; and determining, using the WL endpoint algorithm executed by the computer processor, a processing endpoint of the semiconductor material

### BRIEF DESCRIPTION OF THE DRAWINGS

These and other features of this invention will be more readily understood from the following detailed description of the various aspects of the invention taken in conjunction with the accompanying drawings in which:

FIG. 1 shows a schematic of an exemplary computing environment according to illustrative embodiments;

FIG. 2 shows a schematic of a fabricator and endpoint determinator according to illustrative embodiments;

FIG. 3A shows a semiconductor device prior to formation of a planarization material according to illustrative embodiments;

FIG. 3B shows the semiconductor device following formation of the planarization material according to illustrative embodiments;

FIG. 3C shows the semiconductor device during planarization of the planarization material and during endpoint determination according to illustrative embodiments; and

FIG. 4 shows a flow diagram of an approach for determining a processing endpoint using individually measured target spectra according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

Furthermore, certain elements in some of the figures may be omitted, or illustrated not-to-scale, for illustrative clarity. The cross-sectional views may be in the form of “slices”, or “near-sighted” cross-sectional views, omitting certain background lines, which would otherwise be visible in a “true” cross-sectional view, for illustrative clarity. Furthermore, for clarity, some reference numbers may be omitted in certain drawings.

### DETAILED DESCRIPTION

Exemplary embodiments will now be described more fully herein with reference to the accompanying drawings, in which exemplary embodiments are shown. It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” “exemplary embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

The terms “overlying” or “atop”, “positioned on” or “positioned atop”, “underlying”, “beneath” or “below” mean that a first element, such as a first structure, e.g., a first layer, is present on a second element, such as a second structure, e.g. a second layer, wherein intervening elements, such as an interface structure, e.g. interface layer, may be present between the first element and the second element.

As stated above, disclosed are approaches for determining a processing endpoint using individually measured target spectra. More specifically, one approach includes: measuring a white light (WL) target spectra of a semiconductor device on an individual wafer prior to formation of a polishing/planarization material; inputting the WL target spectra to a WL endpoint algorithm of the semiconductor device following formation of the polishing/planarization material; and determining, using the WL endpoint algorithm, the processing endpoint of the polishing/planarization material of the semiconductor device. In another approach, the endpoint measurement process comprises receiving spectra reflected from the semiconductor device during polishing, and comparing the spectra to the WL target spectra, which is previously stored within a storage device. As such, WL target spectra are measured “as is” (e.g., without simplifications, generalizations, assumptions, etc.) for each wafer to reduce complications inherent with the use of an uncertain and/or estimated target.

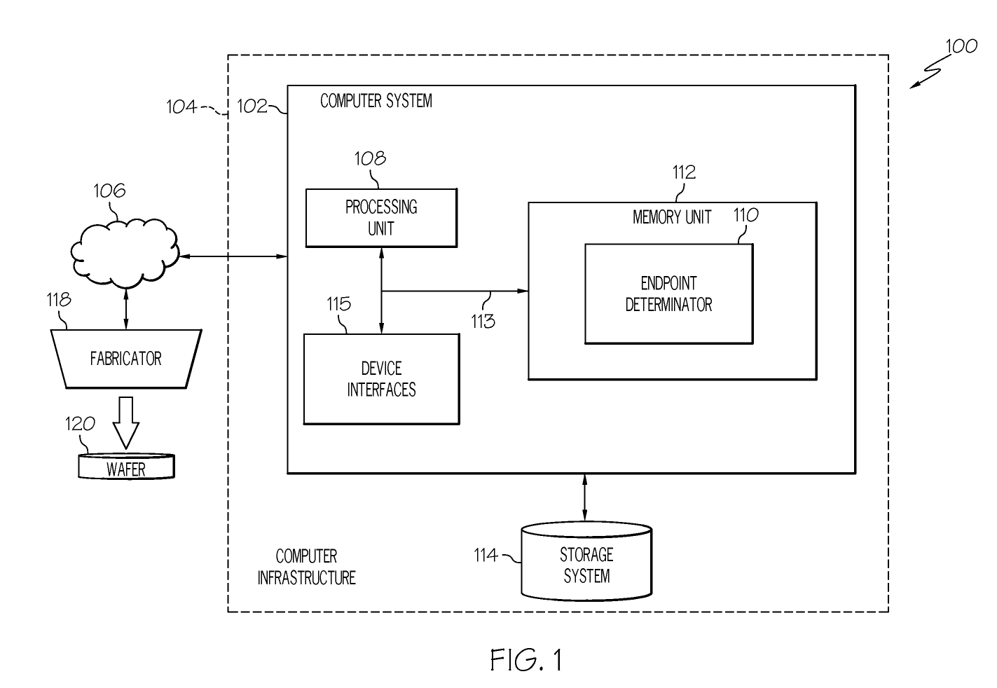

With reference now to the figures, FIG. 1 depicts a system 100 that facilitates determination of a processing endpoint using individually measured target spectra. As shown, system 100 includes computer system 102 deployed within a computer infrastructure 104. This is intended to demonstrate, among other things, that embodiments can be implemented within a network environment 106 (e.g., the Internet, a wide area network (WAN), a local area network (LAN), a virtual private network (VPN), etc.), a cloud-computing environment, or on a stand-alone computer system. Still yet, computer infrastructure 104 is intended to demonstrate that some or all of the components of system 100 could be deployed, managed, serviced, etc., by a service provider who offers to implement, deploy, and/or perform the functions of the present invention for others.

Computer system 102 is intended to represent any type of computer system that may be implemented in deploying/realizing the teachings recited herein. In this particular example, computer system 102 represents an illustrative system for determining a processing endpoint using individually measured target spectra. It should be understood that any other computers implemented under various embodiments may have different components/software, but will perform similar functions. As shown, computer system 102 includes a processing unit 108 capable of operating with a endpoint determinator 110 stored in a memory unit 112, as will be described in further detail below. Also shown is a bus 113 and device interfaces 115.

Processing unit 108 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 108 receives signals transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 108 executes computer program code, such as program code for operating endpoint determinator 110, which is stored in memory unit 112 and/or storage system 114. While executing computer program code, processing unit 108 can read and/or write data to/from memory unit 112 and storage system 114. Storage system 114 may comprise VCRs, DVRs, RAID arrays, USB hard drives, optical disk recorders, flash storage devices, and/or any other data processing and storage elements for storing and/or processing data. Although not shown, computer system 102 could also include I/O interfaces that communicate with one or more hardware components of computer infrastructure 104 that enable a user to interact with computer system 102 (e.g., a keyboard, a display, camera, etc.). As will be described in further detail below, endpoint determinator 110 of computer infrastructure 104 is configured to operate with a fabricator 118 for forming features of an IC.

Although not shown in detail for the sake of brevity, it will be appreciated that in an exemplary embodiment, fabricator 118 may comprise a polishing apparatus operable to polish a semiconductor device on a wafer 120. The polishing apparatus includes a rotatable disk-shaped platen, on which a polishing pad is situated. The polishing pad can be a two-layer polishing pad with an outer polishing layer and a softer backing layer. Optical access through the polishing pad is provided by including an aperture (i.e., a hole that runs through the pad) or a solid window. The solid window can be secured to the polishing pad, although in some implementations the solid window can be supported on a platen and project into an aperture in the polishing pad. The polishing pad is usually placed on the platen so that the aperture or window overlies an optical head situated in a recess of the platen. The optical head consequently has optical access through the aperture or window to a substrate being polished.

The window can be, for example, a rigid crystalline or glassy material, e.g., quartz or glass, or a softer plastic material, e.g., silicone, polyurethane, or a halogenated polymer (e.g., a fluoro-polymer), or a combination of the materials mentioned. The window can be transparent to white light. If a top surface of the solid window is a rigid crystalline or glassy material, then the top surface should be sufficiently recessed from the polishing surface to prevent scratching. If the top surface is near and may come into contact with the polishing surface, then the top surface of the window should be a softer plastic material. In some implementations, the solid window is secured in the polishing pad and is a polyurethane window, or a window having a combination of quartz and polyurethane. The window can have high transmittance, for example, approximately 80% transmittance, for monochromatic light of a particular color, for example, blue light or red light. The window can be sealed to the polishing pad so that liquid does not leak through an interface of the window and the polishing pad.

The polishing apparatus includes a combined slurry/rinse arm. During polishing, the arm is operable to dispense a slurry containing a liquid and a pH adjuster. Alternatively, the polishing apparatus includes a slurry port operable to dispense slurry onto the polishing pad.

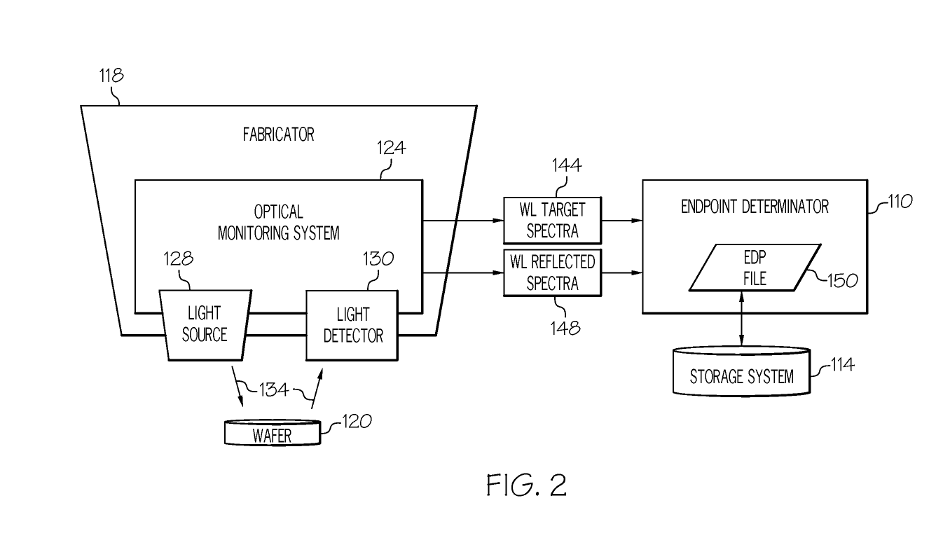

As shown in FIG. 2, fabricator 118 includes an optical monitoring system (OMS) 124, which operates with endpoint determinator 110 to determine a polishing endpoint, as described in greater detail below. It will be appreciated that the location of OMS 124 is not intended as limiting and, instead, may be located external to fabricator 118 in other embodiments. Optical monitoring system 124 includes a light source 128 and a light detector 130. Light 134 (e.g., white light spectra) passes from light 128 and is reflected from wafer 120 back through the optical access, and travels to light detector 130. Light source 128 is operable to emit white light. In one non-limiting implementation, the white light emitted includes light having wavelengths of 200-800 nanometers. A suitable light source is a xenon lamp or a xenon-mercury lamp. Light detector 130 can be a spectrometer, i.e., an optical instrument for measuring properties of light, for example, intensity, over a portion of the electromagnetic spectrum. A suitable spectrometer is a grating spectrometer. An exemplary output for a spectrometer is the intensity of the light as a function of wavelength.

Light source 128 and light detector 130 are connected to endpoint determinator 110, which is configured to control operation of light source 128 and light detector 130, and to receive signals emanating therefrom. Endpoint determinator 110 can include a processor situated near the fabricator 118, e.g., a personal computer. With respect to control, endpoint determinator 110 can, for example, synchronize activation of light source 128 with the rotation of the platen of fabricator 118. In one non-limiting embodiment, endpoint determinator 110 can cause light source 128 to emit a series of flashes starting just before and ending just after the wafer 120 passes over the in-situ monitoring module. Alternatively, endpoint determinator 110 can cause light source 128 to emit light continuously starting just before and ending just after the wafer 120 passes over the in-situ monitoring module.

With respect to receiving signals, endpoint determinator 110 can receive, for example, a signal that carries information describing WL spectra 134 received by the light detector 130. That is, endpoint determinator 110 is configured to receive WL spectra 134 from optical monitoring system 124, and save WL spectra 134 as target WL spectra 144 for subsequent retrieval. In an exemplary embodiment, WL spectra 144 are stored as an endpoint detection signal (EPD) file 150, e.g., within storage device 114. Upon initiation of a polishing/planarization process, EPD file 150 is accessed and imported to a WL endpoint algorithm, as will be described in further detail below.

Endpoint determinator 110 is also configured to receive a reflective spectrum 148, which corresponds to light received during a polishing/planarization process (e.g., CMP). Endpoint determinator 110 can process WL target spectra 144 and reflective spectrum 148 to determine an endpoint of the CMP. That is, endpoint determinator 110 can execute logic (i.e., the endpoint measurement algorithm/process) that determines when a match has been identified based on a comparison of WL target spectra 144 and reflective spectrum 148. When the endpoint is reached, i.e., the match has been identified between the two signals, processing (e.g., planarization) is stopped/suspended.

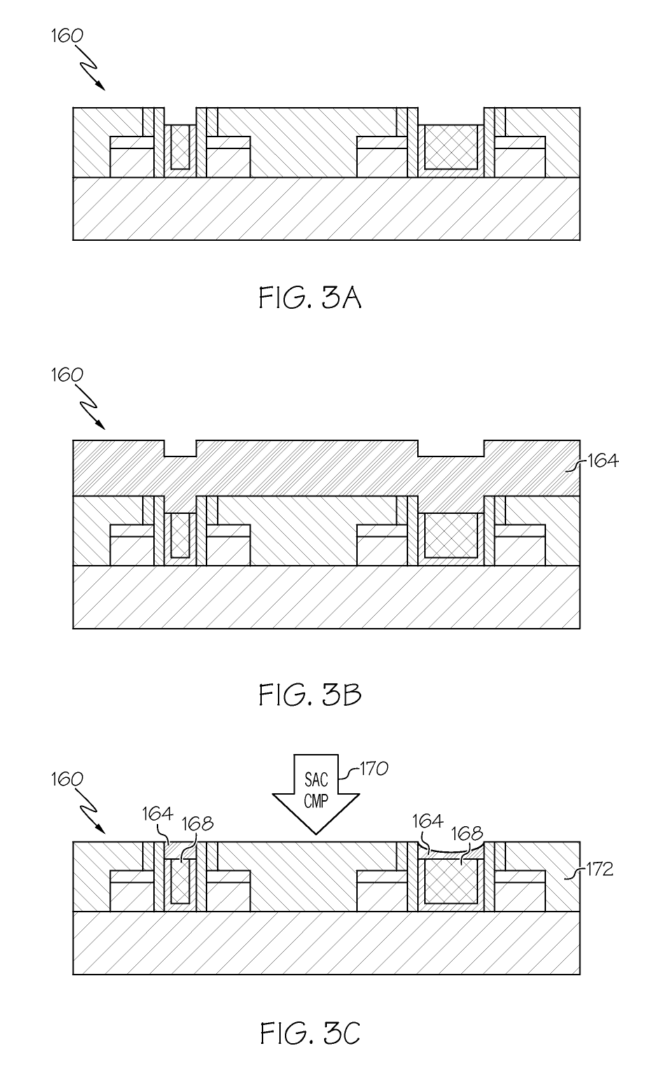

Turning now to FIGS. 3A-C, an exemplary approach for determining a processing endpoint using individually measured target spectra (i.e., WL target spectra 144) will be described in greater detail. In this non-limiting process flow, a semiconductor device 160 is depicted during a selected subset of a self-aligned contact (SAC) CMP processing steps. Semiconductor device 160 (e.g., a FinFET) shown in FIG. 3A is first subjected to a white light (e.g., from light source 128 shown in FIG. 3) to measure the WL spectra of semiconductor device 160, which is provided on an individual wafer. In one embodiment, properties of semiconductor device 160 (e.g., thickness of a layer/material) are measured at multiple locations using the white light during a final deionized (DI) rinse step of the CMP. The locations can be selected as desired, e.g., at critical and/or sensitive locations. In this embodiment, the WL target spectra are determined prior to formation of a planarization material 164 (e.g., silicon nitride, silicon oxide, polysilicon, etc.), which is deposited over semiconductor device 160, as shown in FIG. 3B.

The WL target spectra are stored and then imported to the WL endpoint measurement algorithm upon initiation of a planarization process, which is shown in FIG. 3C. In this embodiment, planarization material 164 is polished using SAC CMP process 170, to remove planarization material 164 from atop oxide 172. Throughout this process, the endpoint measurement algorithm causes endpoint determinator 110 (FIG. 2) to monitor the spectra currently being reflected from semiconductor device 160, and to continuously compare the current spectra to the previously determined WL target spectra.

In one embodiment, the comparison results in a difference calculation between the current spectra and each of the WL target spectrums. The smallest of the calculated differences is appended to a difference trace, which is usually updated once per platen revolution. The difference trace is generally a plot of one of the calculated differences (in this case the smallest of the differences calculated for the current platen revolution). Taking the smallest of the differences can improve accuracy in the endpoint determination process. As an alternative to the smallest difference, another of the differences, for example, a median of the differences or the next to smallest difference, can be appended to the trace. Optionally, the difference trace can be processed, for example, smoothing the difference trace by filtering out a calculated difference that deviates beyond a threshold from preceding one or more calculated differences.

Whether the difference trace is within a threshold value of a minimum is determined, wherein the endpoint is established/called when the difference trace begins to rise past a particular threshold value of the minimum. Alternatively, the endpoint can be called based on the slope of the difference trace. In particular, the slope of the difference trace approaches and becomes zero at the minimum of the difference trace. The endpoint can be called when the slope of the difference trace is within a threshold range of the slope that is near zero. However, if the difference trace is NOT determined to have reached a threshold range of a minimum, the endpoint is not achieved, and polishing is allowed to continue.

Once the endpoint is reached, polishing of planarization material 164 ends. As shown in FIG. 3C, a portion of planarization material 164 remains over contacts 168. However, no significant over/under polishing occurs because the WL endpoint algorithm uses the previously measured WL target spectra to control CMP 170. That is, because the WL target spectra are measured “as is” (e.g., without simplifications, generalizations, assumptions, etc.) for each individual wafer, complications inherent with the use of an uncertain and/or estimated target are reduced.

It can be appreciated that the approaches disclosed herein can be used within a computer system to determine a processing endpoint using individually measured target spectra. In this case, as shown in FIGS. 1-2, the endpoint determinator 110 can be provided, and one or more systems for performing the processes described in the invention can be obtained and deployed to computer system 102 (FIG. 1). To this extent, the deployment can comprise one or more of: (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary computer system 104 (FIG. 1) may be described in the general context of computer-executable instructions, such as program modules, being executed by a computer. Generally, program modules include routines, programs, people, components, logic, data structures, and so on, which perform particular tasks or implement particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

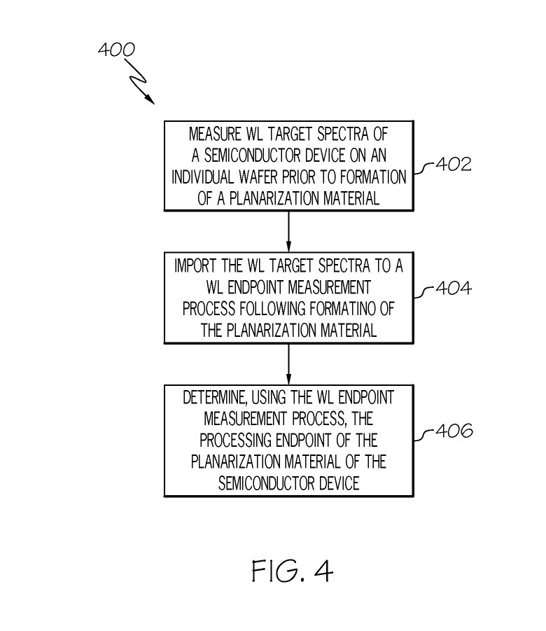

As depicted in FIG. 4, a system (e.g., computer system 104) carries out the methodologies disclosed herein. Shown is a process flow 400 for determining a processing endpoint using individually measured target spectra. At 402, WL spectra of a semiconductor device on an individual wafer are measured prior to formation of a planarization material, and stored within a storage device as WL target spectra. At 404, the WL target spectra are imported to a WL endpoint algorithm following formation of the planarization material. At 406, it is determined, using the WL endpoint algorithm, the processing endpoint of the planarization material of the semiconductor device.

Process flow 400 of FIG. 4 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, endpoint determinator 110 (FIGS. 1-2) may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electro-magnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is apparent that there has been provided approaches for determining a processing endpoint using individually measured target spectra. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for determining a processing endpoint using individually measured target spectra, the method comprising the computer-implemented steps of:
measuring a white light (WL) spectra of a semiconductor device on an individual wafer prior to formation of a semiconductor material;
storing the WL spectra as a target WL spectra;
inputting the WL target spectra to a WL endpoint algorithm following formation of the semiconductor material; and
determining, using the WL endpoint algorithm, a processing endpoint of the semiconductor material.

2. The method of claim 1, the processing endpoint calculated during a polishing of the semiconductor material.

3. The method according to claim 1, the processing endpoint calculated during a chemical mechanical planarization.

4. The method of claim 1, the planarization material comprising at least one of: silicon nitride, silicon oxide, and polysilicon.

5. The method of claim 2, further comprising:
monitoring a spectrum reflected from the semiconductor device during the polishing of the semiconductor material; and
comparing the spectrum reflected from the semiconductor device to the WL target spectra.

6. The method according to claim 5, the determining the processing endpoint comprising identifying a match between the spectrum reflected from the semiconductor device and the WL target spectra.

7. The method according to claim 6, wherein polishing of the semiconductor material continues until the match is identified.

8. The method according to claim 2, further comprising storing, in a storage device, the WL target spectra as an endpoint detection signal (EPD) file.

9. The method according to claim 8, the importing comprising retrieving the EPD file upon initiation of the polishing of the semiconductor material.

10. A computer program product for determining a processing endpoint using individually measured target spectra, the computer program product comprising:
a computer readable storage device storing computer program instructions, the computer program instructions being executable by a computer processor, the computer program instructions including:
measuring a white light (WL) spectra of a semiconductor device on an individual wafer prior to formation of a semiconductor material;
storing the WL spectra as a target WL spectra;
inputting the WL target spectra to a WL endpoint algorithm following formation of the semiconductor material; and
determining, using the WL endpoint algorithm, a processing endpoint of the semiconductor material.

11. The computer program product of claim 10, the processing endpoint calculated during a polishing of the of planarization material.

12. The computer program product of claim 10, the processing endpoint calculated during a chemical mechanical planarization.

13. The computer program product of claim 10, the planarization material comprising at least one of: silicon nitride, silicon oxide, and polysilicon.

14. The computer program product of claim 11 further comprising computer program instructions including:
monitoring a spectrum reflected from the semiconductor device during the polishing of the planarization material; and
comparing the spectrum reflected from the semiconductor device to the WL target spectra.

15. The computer program product according to claim 14, the computer program instructions for determining the processing endpoint comprising identifying a match between the spectrum reflected from the semiconductor device and the WL target spectra.

16. The computer program product according to claim 15, wherein polishing of the planarization material continues until the match is identified.

17. The computer program product according to claim 11, further comprising computer program instructions including:
storing, in a storage device, the WL target spectra as an endpoint detection signal (EPD) file; and
retrieving the EPD file upon initiation of the polishing of the planarization material.

18. A method for determining a processing endpoint using individually measured target spectra, the method comprising:
measuring a white light (WL) spectra of a semiconductor device on an individual wafer prior to formation of a semiconductor material;
storing the WL spectra as a target WL spectra;
inputting, by a computer processor, the WL target spectra to a WL endpoint algorithm following formation of the semiconductor material; and
determining, using the WL endpoint algorithm executed by the computer processor, a processing endpoint of the semiconductor material.

19. The method of claim 18, the determining the processing endpoint comprising:
receiving, by the computer processor, a spectrum reflected from the semiconductor device during polishing of the planarization material; and
comparing, by the computer processor, the spectrum reflected from the semiconductor device to the WL target spectra.

20. The method according to claim 19, further comprising identifying, by the computer processor, a match between the spectrum reflected from the semiconductor device and the WL target spectra.
